(19) United States
(12) Patent Application Publication
(10) Pub. No.: US 2017/0064548 A1
(43) Pub. Date: Mar. 2, 2017

(54) METHOD OF AND SYSTEM FOR GAINING SECURE ACCESS TO A SERVICE

(71) Applicant: secunet SECURITY NETWORKS Aktiengesellschaft, Essen (DE)

(72) Inventor: Armin WAPPENSCHMIDT, Hamburg (DE)

(21) Appl. No.: 14/833,675

(22) Filed: Aug. 24, 2015

Related U.S. Application Data
(63) Continuation-in-part of application No. 13/946,352, filed on Jul. 19, 2013, now abandoned.

(30) Foreign Application Priority Data
Aug. 1, 2012 (EP) 12178889.7

(51) Int. Cl. H04W 12/06; H04W 4/02

(52) U.S. Cl. CPC H04W 12/06; H04W 4/021; H04W 88/02

(57) ABSTRACT

A service is in a spatially defined trustworthy area holding at least one network component and defined by a reference data set stored on a user device and/or on the network component. When a user device moves into the trustworthy area, to connect with the network, the reference data set defining the trustworthy environment is compared with entry data detected from the user device, and the user device is only connected with the network if there is at least a rough match between the reference data set and the entry data falls. The device contacts the network component and retrieves a password saved therein in, and then communicates the password to the service that is then enabled for the user device if the password stored in the service matches the password that has been communicated by the user device to the service.

### CROSS-REFERENCE TO RELATED APPLICATIONS

This application is a continuation-in-part of copending patent application Ser. No. 13/946,352 filed 19 Jul. 2013 with a claim to the priority of EP 12 178 889.7 filed 1 Aug. 2012.

### FIELD OF THE INVENTION

The present invention relates to gaining secure access to a service. More particularly this invention concerns a method of and system for gaining such access in a defined trustworthy area.

### BACKGROUND OF THE INVENTION

Methods of the above-described type are well known in practice. Security-related requirements frequently dictate that services must be enabled or the encrypted data must be decrypted before accessing certain services or encrypted data. Protecting certain services or data is necessary, in particular, whenever these devices are operated outside a defined trustworthy area. Blocking or encrypting data can generally be omitted within a trustworthy area since access to the service or data is effected exclusively by trustworthy authorized entities or users. The disadvantage inherent in the methods known in practice in this case is the fact that the services or data would then not be protected if the service is accessed outside the trustworthy area or data are used outside the trustworthy area. The approach in practice to avoid this problematic situation is thus to employ a password by which the services or data can be protected against unauthorized use. Following a predetermined period of inactivity in using the service or accessing the data, however, the password must be reentered, and this means that utilization of the service or the data is to some extent less user friendly.

### OBJECTS OF THE INVENTION

It is therefore an object of the present invention to provide an improved method of and system for gaining secure access to service.

Another object is the provision of such an improved method of and system for gaining secure access to service that overcomes the above-given disadvantages, in particular that is very user friendly.

### SUMMARY OF THE INVENTION

In order to gain secure access to a service in a spatially defined trustworthy area holding at least one network component forming a network, the trustworthy area is defined based on a reference data set that contains at least one data set composed of the group consisting of GPS data, a certain WLAN or Bluetooth component, certain private network data, a certain GSM cell site. The reference data set is stored on a user device and/or on the network component for later determination if the user device and/or the network component is within the trustworthy area. A password is saved in the network component. Then a user device is moved into the trustworthy area, and in order to connect the user device with the network, the reference data set defining the trustworthy environment is compared with entry data detected from the user device, and the user device is only connected with the network if a specified maximum deviation between the reference data set and the entry data falls below a predetermined value. The user device contacts the network component device and retrieves the password saved in the network component. The user device then communicates the password to the service, which in turn is enabled for the user device if a password stored in the service matches the password that has been communicated by the user device to the service.

GPS data within the scope of the invention refers to a spatial range of the trustworthy area. For example, a point is determined by GPS coordinates whose point is the center of a circle with a certain radius r. In another embodiment, GPS data is used to determine the border of the trustworthy area. The trustworthy area thus can also be shaped rectangular or can have any other shape. The shape of the trustworthy area is preferably in the form of the footprint of a building or in the form of the premises of, for example, a company. Of course, the trustworthy area can be shaped in the form of a private home or in the form of the premises of the private home. The trustworthy area preferably has a position and a shape that are protected by walls or fences.

A reference data set with data of a certain WLAN or Bluetooth component also restricts the position and the shape of the trustworthy area simply by the range of the certain WLAN or Bluetooth component. It is advantageous that the range of the certain WLAN or Bluetooth component is protected by walls or fences. With an according number of WLAN or Bluetooth components the shape of a building or the shape of the premises can be roughly reproduced.

In another embodiment, the reference data set with certain private network data defines the position and the shape of the trustworthy area. The term “private network data” means all the data of other network components that can be seen from a network component if the network component is connected with the according private network. Then, the network component can see many or all the other network components within this private network. The other network components are characterized by their private network data, for example their private IP addresses, their names, MAC-addresses, identifications, serial numbers and so on. All this data is called private network data. A certain amount of this data results in a very high probability that this combination of data is unique and thus defines unambiguously a certain private network of a certain company/building/authority. Here, the position and the shape of the certain private network define the position and the shape of the trustworthy area.

Preferably, the certain private network data comprises private network addresses. Private network addresses within the scope of the invention include the addresses of components and are in the trustworthy area and are not routed. The term “private network addresses” is used in the meaning of the standards RFC 1918 for IPv4 and RFC 4193 for IPv6. They are thus not allocated to any specific organization. For example, several private network addresses altogether form the reference data set. This combination of network addresses can be modeled so that this private network data gives an unambiguous definition of the position and the shape of the trustworthy area since only the private network of company X has this combination of network addresses. This means that the network of the trustworthy area itself determines position and shape of the trustworthy area. Thus, each user device connected with a private network of the trustworthy area, and that can see the aforementioned private network data, is within the trustworthy area. This means that, for example, rooms with a connection possibility to the private network are part of the trustworthy area. Rooms without connection possibility according to this embodiment are thus not part of the trustworthy area even if they belong to the premises. Thus, the trustworthy area of this embodiment is usually delimited by walls.

In a further embodiment, the reference data set is made of data concerning a certain GSM cell site. For example, the trustworthy area is defined by the range of a cell site with a predetermined identification number. The trustworthy area can also be restricted to a certain cell site and wherein the trustworthy area is restricted to a predetermined span of signal strength of the GSM cell site. The reference data set can also concern two or more GSM cell sites that can be adjacent each other and that determine the position and the shape of the trustworthy area. It is also possible that the trustworthy area is defined by an overlap of overlapping GSM cell sites. The trustworthy area defines by GSM cell sites is preferably protected by walls and/or fences.

In further embodiments, said different definitions of trustworthy areas can be combined. For example, the reference data set comprises GPS data as well as overlapping GSM cell sites. Another example is the combination of certain private network data combined with the range of a WLAN component. Of course, a variety of other combinations is possible.

In certain embodiments it is recommended to use at least two different data types within the reference data set for definition of the trustworthy area. When defining the trustworthy area by private network data it is advantageous to combine these data with, for example, GPS data, since there is the possibility of implementing virtual private networks. If the user device is connected with the private network by a virtual private network, the user device might be located outside of this building or premises. Then, the user device can see the network components of the trustworthy area which means that the user device seems to be within, for example, company buildings which is not the case.

It is therefore recommended to compare not only the private network data but also, for example, GPS data. If the GPS data imply that the user device is located, for example at the home of an employee or at another building of the company, the user device is still within the trustworthy area if the home of the employee or the other building of the company are defined as being part of the trustworthy area. Thus, in case of the connection between the user device and the private network by means of a virtual private network, the location of the user device should be checked via GPS data or GSM cell site data or via the range of WLAN or Bluetooth components if it is still located in the trustworthy area.

The reference data set defines in each case the trustworthy area unambiguously or at least with a very high probability. Thus, the trustworthy area is spatially predetermined by the reference data set. If a user device is additionally connected with the network, the network itself is extended by one device but not its spatial range and thus not the trustworthy area. If, for example, a user device is logged in and thus gains access to a certain service, this access is not equivalent with an enlargement of the trustworthy area since the trustworthy area is predetermined by the reference data set. This means that the user device, in order to connect with the network of the trustworthy area, has to be physically moved into the trustworthy area. This also means that the user device is a physical and tangible element and not just a virtual element like an account.

The entry data especially preferably matches the reference data set. The entry data detected from the user device comprises at least one data set that is contained in the reference data set. For example, the entry data includes at least one data set selected from the group consisting of current GPS data, a current visible WLAN or Bluetooth component, current visible private network data, current visible GSM cell site. It is recommended that the user device has at least one sensor unit that can detect or determine the entry data. The sensor unit is advantageously a GPS sensor, a WLAN or Bluetooth antenna, a network interface controller, a GSM antenna.

Within the scope of the invention, secure access refers to the fact that access to the service is protected against being achieved by an unauthorized entity. The service is, for example, an internet service, preferably, a web-mail service. It is possible for the service to be provided in the trustworthy area in the form of access to a user account preferably on a local device, for example, a computer (PC).

In one embodiment, the service is a mass storage medium, for example, a file server and/or a network attached storage server (NAS server) including a preferably encrypted file system. The encrypted file system is preferably decrypted whenever secure access is enabled for the user device to use the mass storage medium. The file system of the mass storage medium is advantageously encrypted whenever the mass storage medium is used outside the trustworthy area. By way of recommendation, the trustworthy area is a network that is separated from the public Internet, preferably by a router. It is possible for the network to be provided by a computer.

It has been found advantageous for the password to contain information of a network component in the trustworthy area. This approach ensures that no additional memory is required in the network component or in the network components in which the password must be stored. It is possible for the password to be composed of the network addresses or parts of the network addresses of the individual network components that are integrated into the trustworthy area.

In an especially preferred aspect, the network component uses the integration data set and the reference data saved in the network component to proactively determine whether the network component belongs to the trustworthy area.

In order to locate the network components in the trustworthy area, the reference data set defining the trustworthy area is preferably compared with an integration data set supplied by the network components and that are integrated exclusively within the trustworthy area only if a specified maximum deviation between the reference data set and the integration data set falls below a predetermined level. The integration data set comprises at least one data set that is selected from the group consisting of GPS data, a certain WLAN or Bluetooth component, certain private network data, a certain GSM cell site.

In an especially preferable approach, the data set contained in the integration data set is also a constituent part of the reference data set. The maximum deviation is preferably specified or specifiable, thereby allowing the security level of the method according to the invention to be adjusted. As the allowable deviation becomes higher, the security level accordingly becomes lower. The security level of the method according to the invention increases as the allowable deviation between the reference data set and the integration data set becomes smaller. The network component is preferably in the trustworthy area or integrated into the trustworthy area if the integration data set supplied by the network component is identical to the reference data set. In one embodiment, if the integration data set does not match the reference data set, or a specified deviation is exceeded between the integration data set and the reference data set, the network component is considered to be an external network component, or considered not to belong to the trustworthy area. In this case, the network component is not a constituent part of the trustworthy area. The network component advantageously has at least one sensor that can detect or determine the integration data set—preferably, the data sets contained in the integration data set or the data set contained in the integration data set. The sensor in one embodiment is a GPS sensor.

In an especially preferred aspect, the network component refuses to allow the user device to retrieve the password stored in the network component whenever the user device is located outside the trustworthy area. The network component advantageously responds to a password request from the user device only when the user device has been connected with the network. Advantageously, no password is saved in the user device. Whenever the user device is located, for example, outside the trustworthy area, the user is required to enter the password in order to use the user device to obtain secure access to the trustworthy area and/or to the service. According to the invention, the network component refuses to allow the user device to retrieve the password stored in the network component if the network component is located outside the trustworthy area. Whenever the integration data set determined by the network component exceeds a specified deviation from the reference data set, the network component refuses to disclose the password.

It has been found advantageous if at least two and preferably a plurality of network components is/are in the trustworthy area, one respective part of the password being stored in each of the at least two network components of the trustworthy areas. One part of the password is preferably saved in each network component of the trustworthy area. The parts of the password saved in the individual network components advantageously differ from each other. It is possible for at least two parts of the password to be the same, and optionally for all parts of the password to be the same or identical. It is possible for the address of the network component to be used as the password. Access to the service is possible with the password. In one embodiment, decryption of the file system is effected by the password that is preferably used as the decryption key.

The user device advantageously retrieves the parts of the password from those network components in which parts of the password are stored. It is recommended that the parts of the password retrieved by the user device be combined to form the password in the user device. In an especially preferred embodiment, the password is either not saved or is only temporarily saved in the user device. Addresses are preferably stored in the user device for the network component or network components to be contacted, from which network component the password is retrieved or from which parts of the password are retrieved.

According to the invention, retrieval of the password or the parts of the password is effected proactively by the user device as soon as the user device has been advantageously connected with the network or with the service. If the user device has not been connected with the network, and/or if a network component in which part of the password is stored is not in the trustworthy area, according to the invention no access can be established proactively to the service by the user device. Within the scope of the invention, proactively means that the user device in terms of retrieval of a password automatically contacts the network component in the trustworthy area and/or the network components in the trustworthy area in order to retrieve the password stored in the network component or the parts of the password stored in the individual network components. It is possible for the user device to effect a retrieval of the password proactively only if the user device is in the trustworthy area. It is recommended that the network component or the network components each proactively or independently determine whether they belong to the trustworthy area.

In addition, the invention teaches a system for achieving the object of the invention, by which a service is securely accessible in a spatially defined trustworthy area. The trustworthy area is defined based on a reference data set that contains at least one data set composed of the group consisting of GPS data, a certain WLAN or Bluetooth component, certain private network data, a certain GSM cell site. The reference data set is stored on a user device and/or on a network component for later determination if the user device and/or the network component is within the trustworthy area. The defined trustworthy area comprises at least one network component in which a password is saved. The at least one network component forms a network. The user device can be moved into the trustworthy area, and in order to connect the user device with the network, the reference data set defining the trustworthy area is compared with entry data detected from the user device, and the user device is only connected with the network if a specified maximum deviation between the reference data set and the entry data falls below a predetermined value. This effects a communication with the network component to retrieve the password. Then the user device communicates the password to the service, and the service is enabled for the user device if a password stored in the service matches the password communicated by the user device.

It is recommended that the trustworthy area preferably be a private network. Within the scope of the invention, private network refers to a company network and/or a network in a private residence and/or a computer center. It is recommended that the network component be a passive network component. The network component is, for example, a DSL switch, a filter, an amplifier, or the like. Within the scope of the invention, passive network component refers, in particular, to the fact that this network component does not generate any data 10 or signals.

It is possible for the network component to be an active network component. The active network component is at least one component that is selected from the group consisting of server, NAS server, Bluetooth device, printer, mass storage means. The user device is advantageously a network-capable device. In one embodiment, the user device is selected from the group consisting of portable computer (notebook), mobile telephone, smart phone, tablet PC.

The invention is based on the idea that the method according to the invention and the system according to the invention are characterized by a surprising ease of use and high degree of user friendliness. Frequently entering a password to enable access to a service is limited by the method according to the invention to situations in which the user device is not within a trustworthy area. The method according to the invention makes it possible to eliminate the need to enter a password without compromising security whenever the user device is located in the trustworthy area. The user device can be designed without any specially secured memory due to the fact that the individual components enabling access to the service are stored in the trustworthy area. Since an unauthorized third party is unaware as to where and how the password is obtained in the method according to the invention or in the system according to the invention, unauthorized access to the service is impossible, or is possible only by costly means. As a result, the method according to the invention is characterized by a high level of security and surprising ease of use.

### BRIEF DESCRIPTION OF THE DRAWING

The above and other objects, features, and advantages will become more readily apparent from the following description, reference being made to the accompanying drawing in which:

FIG. 1 is a schematic diagram of a system according to the invention for carrying out the method according to the invention in which a user device is in a trustworthy area; and

FIG. 2 is another such diagram showing a system according to the invention for carrying out the method according to the invention in which the user device is outside the trustworthy area.

### DETAILED DESCRIPTION OF THE INVENTION

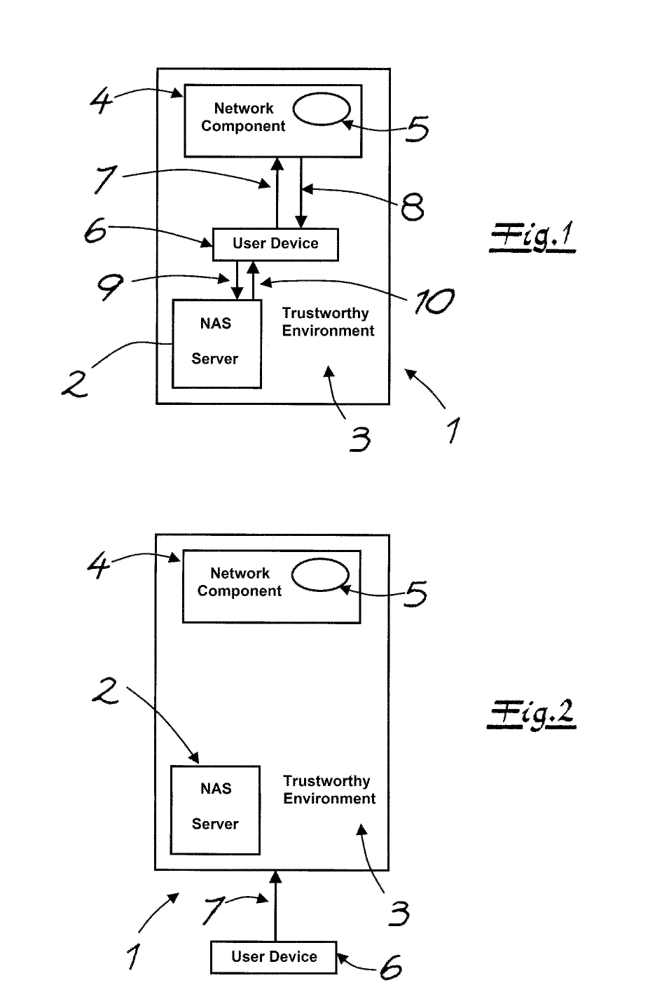

As seen in FIG. 1 a system 1 in which a service in the form of a NAS server (Network Attached Storage Server) 2 is in a defined trustworthy area 3. As indicated in FIG. 1, a network component 4 is in the trustworthy area 3. The network components 4 each have a sensor 5 that can determine integration data that is compared with a reference data set stored in the network component 4. Here, the sensor 5 determines a position for the network component 4 and compares the obtained position data with position data contained in the reference data set. Here and in FIGS. 1 and 2, the GPS data obtained by the sensor 5 and the position data stored in the reference data set match, with the result that the network component 4 determines that it belongs in the trustworthy area 3 and is integrated into the trustworthy area 3.

FIG. 1 furthermore shows that a user device 6 has been moved into the trustworthy area 3, and the user device 6, preferably and in FIG. 1, determines that it belongs in the trustworthy area 3 by a comparison with the reference data set stored in the user device 6 by using entry data determined by the user device 6. In the embodiment in FIG. 1, the user device 6 determines that it is a constituent part of the trustworthy area 3. The user device connected with the network of the trustworthy area 3 can now send a password request to the network component 4.

Arrow 7 indicates that the user device 6 is sending the password request to the network component 4 to retrieve a password that is stored in the network component 4. Since both the network component 4 and the user device 6 are each in the trustworthy area 3, the network component 4 responds to the request 7 by sending a password stored in the network component 4 to the user device 6, as illustrated by arrow 8. Using the password obtained from the network component 4, the user device 6 logs in to the NAS server 2 as shown by arrow 9.

Here, the NAS server 2 decrypts the files stored in the unillustrated file system of the NAS server 2 if the password stored in the file system of the NAS server 2, as illustrated in FIG. 1, matches the password communicated by the user device 6 to the NAS server 2. Arrow 10 represents data transfer between the NAS server 2 and the user device 6.

FIG. 2 shows that the user device 6 is outside the trustworthy area 3. The user device 6 compares the entry data determined by the user device 6 with the reference data set stored in the user device 6 and in doing so finds there is no match. Since the user device 6 in FIG. 2 is outside the trustworthy area 3, the result of the password request 7 is that the device cannot reach the network component 4 in the trustworthy area 3. It is consequently impossible by means of the password request 7 for the user device 6 to request the password that is required to access the NAS server 2. FIG. 2 illustrates that it is impossible to effect access to the NAS server 2 after an unsuccessful proactive password request by the user device 6. FIG. 2 does not illustrate that access to the NAS server 2 can be established by manually entering a password in the user device 6.

I claim:

1. A method of gaining secure access to a service in a defined spatially defined trustworthy area holding at least one network component forming a network, the trustworthy area being spatially defined based on a reference data set that contains at least one data set from the group consisting of certain GPS data, a certain WLAN or Bluetooth component, certain private network data, and a certain GSM cell site, the method comprising the steps of:
storing the reference data set on a user device and/or on the network component for later determination if the user device and/or the network component is within the trustworthy area;
saving a password in the network component;
moving the user device into the trustworthy area;
comparing the reference data set defining the trustworthy area with entry data detected from the user device in order to connect the user device with the network;
connecting the user device with the network only if a specified maximum deviation between the reference data set and the entry data falls below a predetermined value;
contacting the network component with the user device and retrieving the password saved in the network component with the user device;
communicating the password from the user device to the service; and
enabling the service for the user device if a password stored in the service matches the password that has been communicated by the user device to the service.

2. The method defined in claim 1, wherein the password contains information of a network component that is in the trustworthy area.

3. The method defined in claim 1, further comprising the step of:
comparing the reference data set defining the trustworthy area with integration data supplied by the network component in order to locate the network component in the trustworthy area, and
considering the network component to belong to the trustworthy area only if a specified maximum deviation between the reference data set and the integration data falls below a predetermined value.

4. The method defined in claim 1, further comprising the step of:
the network component refusing to allow the user device to retrieve the password stored in the network component if the user device is located outside the trustworthy area.

5. The method defined in claim 1, further comprising the step of:
the network component refusing to allow the user device to retrieve the password stored in the network component if the network component is located outside the trustworthy area.

6. The method defined in claim 1, wherein at least two and preferably a plurality of network components is/are in the trustworthy area, the method further comprising the step of:
storing respective parts of the password in each of the at least two network components of the trustworthy area.

7. The method defined in claim 7, further comprising the step of:
the user device retrieving the respective parts of the password from the network components in which the parts of the password are stored.

8. The method defined in claim 8, further comprising the steps of:
combining the parts of the password retrieved by the user device to form the password in the user device.

9. A system for controlling access to a service in a spatially defined trustworthy area that is spatially defined based on a reference data set that contains at least one data set from the group consisting of certain GPS data, a certain WLAN or Bluetooth component, certain private network data, a certain GSM cell site, the system comprising:
at least one network in the trustworthy area having at least one network component holding a password;
a user device that can be moved into the trustworthy area;
the reference data set stored on the user device and/or on the network component for later determination if the user device and/or the network component is within the trustworthy area;
means for communicating between the user device integrated into the trustworthy area and the network component;
means for comparing the reference data set defining the trustworthy area with entry data from the user device in order to connect the device with the network; and connecting the user device with the network only if a specified maximum deviation between the reference data set and the entry data falls below a predetermined value;
means in the user device for retrieving the password in the network component and for communicating the password to the service; and
means in the service for enabled use by the user device if a password stored in the service matches the password that has been communicated by the user device.

10. The system defined in claim 10, wherein the trustworthy area is preferably a private network.

11. The system defined in one of claims 10, wherein the network component is a passive network component.

12. The system defined in one of claims 10, wherein the network component is an active network component.

13. The system defined in claim 10, wherein the user device is a network-capable device.

14. The system defined in claim 10, wherein the password contains an address of a network component that is in the trustworthy area.
